(19) United States
(12) Patent Application Publication
(10) Pub. No.: US 2008/0205640 A1
(43) Pub. Date: Aug. 28, 2008

(54) Digital content delivery system and method

(75) Inventors: Chaim D. Shen-Orr, Haifa (IL); Eli Hibshoosh, Tel Aviv (IL); Steve Epstein, Hashmonaim (IL); Stephanie Wald, Givat Zeer (IL); Yaakov Belenky, Maaleh Adumim (IL); Yigal Shapiro, Kiryat Motzkin (IL)

Correspondence Address: Ladas & Parry, 26 West 61st Street, New York, NY, 10023, US

(73) Assignee: NDS LIMITED.

(21) Appl. No.: 12/150,746

(22) Filed: Apr. 30, 2008

Related U.S. Application Data
(62) Division of application No. 09/914,297, filed on Dec. 18, 2001.
(60) Provisional application No. 60/174,530, filed on Jan. 5, 2000.
(60) Provisional application No. 60/195,032, filed on Apr. 6, 2000.

(51) Int. Cl. H04K 1/04

(52) U.S. Cl. 380/35

(57) ABSTRACT

A system and a method for flexible, yet secure distribution of digital content items, optionally with an automatic payment mechanism for purchasing such content. The present invention supports the distribution of content to end user devices from a central distribution point, as in client-server models and variations thereof, and/or peer-to-peer distribution, for example between end user devices. In addition, the present invention also supports distribution models within either of these mechanisms for unitary distribution, to a specified end user device, or broadcast/multicast distribution, to a plurality of end user devices. In any case, in order for the distributed content to be operative, for example to be “played back” or otherwise displayed, the recipient end user device must be in communication with a network control center. The network control center then enables the recipient end user device to play back or otherwise display the received content, for example by sending a code to the recipient end user device. Optionally, the network control center may require payment to be received before enabling the content for the recipient end user device. Thus, the present invention supports flexible distribution of content according to a number of different distribution models, while still preventing unauthorized play back or other display throughout the lifecycle of the digital content item, and optionally enabling assured payments.

### FIELD OF THE INVENTION

The present invention relates to a system and a method for digital content delivery, and in particular, to such a system and method which enable such digital content to be securely delivered with a mechanism for assured payment.

### BACKGROUND OF THE INVENTION

Digital content can easily and efficiently be delivered through any type of suitable network, such as a cable network and/or a computer network. In particular, digital content can be efficiently delivered to individual users upon request, thereby enabling users to receive personalized content “on demand”. Such personalization is particularly useful for digital content for display and/or playback through various types of media devices, such as video data and audio data, in which the taste of the user is highly individualized. For example, users could select individual portions of music, television programs, movies and other types of entertainment, and receive these selections as digital content.

However, in order for digital content to be fully effectively delivered to users, a number of mechanisms need to be provided. First, if payment is required, then the digital content should be secure against theft, such that only authorized users can retrieve and display the digital content. Second, the user should also easily be able to effect payment where required, in order to encourage proper payment and usage. Third, neither of these mechanisms should interfere with the efficient delivery and display/playback of the digital content. Fourth, the authorized user should also optionally be permitted to play back or otherwise display the digital content more than once, while still preventing unauthorized users from gaining access to the digital content. In addition, users should be able to use digital content in substantially the same manner in which analog content is presently used. For example, users should be able to keep a reasonable number of copies to be used by the same person at different locations, such as at home, in the automobile, at the office and so forth. In addition, such copies should be usable by a reasonable, limited number of family members.

One attempt to provide such effective mechanisms is described in U.S. Pat. Nos. 5,282,249 and 5,481,609, which are hereby incorporated by reference as if fully set forth herein. The disclosed system enables an analog signal containing media content to be broadcast widely, yet only to be played back or otherwise displayed by authorized users. This signal could contain a television program for example. The signal is scrambled, such that the authorized users are able to unscramble the signal and play back or otherwise display the media content only with the proper security device, such as a smart card for example. Thus, widely received media content is still protected from access by unauthorized users.

Another attempted solution is described in published European Patent Application No. EP 0858184, which discloses a digital recording protection system and which is hereby incorporated by reference as if fully set forth herein. The disclosed system enables the digital content to be sent in a scrambled format, such that the digital content cannot be read and/or displayed without a key. The key is obtained from a control message, which is only sent to authorized users. Preferably, the key is obtained from coded information contained within the Entitlement Control Message, or ECM, for generating a code word associated with the ECM. Thus, only authorized users are able to correctly read and/or display the digital content.

In addition, the system and method described in European Patent Application No. EP 0858184 enable the authorized user to record and playback or otherwise display the digital content, while preventing the user from producing and distributing multiple playable copies of the digital content to other, non-authorized users. Therefore, the authorized user is able to fully use and enjoy the digital content, while the content itself is still protected from unauthorized use.

As described in European Patent Application No. EP 0858184, and as shown in background art FIG. 1 taken from this Application, such a system includes a media device 100, such as a television set, for playing the digital content, such as a television program for example. Media device 100 is connected to an integrated receiver-decoder (IRD) 110, for receiving and decoding the scrambled digital content. The system also features a removable security element 120, such as a smart card for example, for providing control words for unscrambling, or otherwise rendering into a clear format, the scrambled digital content by IRD 110. In addition, the system features a digital VCR 130 for communicating with media device 100 and IRD 110. Digital VCR 130 is able to record the digital content for later playback and/or display by media device 100.

IRD 110 receives scrambled digital content which features a plurality of ECMs, each of which is associated with, and is typically followed by, a scrambled digital data segment, containing the actual digital content. Each ECM includes coded information which can be used to generate a code word for unscrambling the associated scrambled digital data segment. Typically, removable security element 120 generates the code word. IRD 110 is then able to unscramble the scrambled digital content, for example for being played by media device 100.

Background art FIG. 2, also taken from European Patent Application No. EP 0858184, is a flow diagram illustrating the production of the scrambled digital content. As shown, the scrambled digital content is produced as an SDDS (scrambled digital data stream) 140, featuring a plurality of ECMs such as an nth ECM 145, and a plurality of associated SDSEGs such as an nth SDSEG (scrambled digital data segment) 150 which is associated with nth ECM 145. IRD 110 of FIG. 1, in cooperation with removable security element 120, is able to use SDDS 140 in order to form a recording SDDS 165. Recording SDDS 165 is produced with the addition of a TECM (transformed ECM) key, which is permanently associated with the system of FIG. 1, even if removable security element 120 is changed, replaced or exchanged, for example. This TECM key is used to make a plurality of TECMs, shown as nth TECM 175, from the code words of the ECMs. Thus, a system which did not feature the correct TECM key could not unscramble the recording SDDS 165 for playing back or otherwise displaying the digital content, while the authorized user is always able to play back or otherwise display the recorded digital content as long as the TECM key is available.

### SUMMARY OF THE INVENTION

None of the disclosed background art solutions permits a payment mechanism to be incorporated into the security system. Furthermore, none of the references teaches or discloses an automated payment mechanism, which could for example, enable authorized users to both transmit digital content to other users, and to pay for such content, as well as enabling users to purchase digital content automatically. Also, none of the references teaches or discloses a secure device for unscrambling the digital content while simultaneously protecting such content from unauthorized content or “hacking” at the time of play back or other display. Thus, although the background art systems fulfill a portion of the requirement for a flexible yet secure digital content protection system, they do not complete fulfill the need for such a system.

Therefore, there is an unmet need for, and it would be highly useful to have, a system and a method for secure digital content delivery, which enables payment for content to be automatically effected, yet which enables the authorized user to access the digital content more than once.

The present invention fulfills these needs by providing a system and a method for flexible, yet secure distribution of digital content items, optionally with an automatic payment mechanism for purchasing such content. The present invention supports the distribution of content to end user devices from one or more central distribution points, as in client-server models and variations thereof, and/or peer-to-peer distribution, for example between end user devices. In addition, the present invention also supports distribution models within either of these mechanisms for unitary distribution, to a specified end user device, or broadcast/multicast distribution, to a plurality of end user devices. In any case, in order for the distributed content to be operative, for example to be “played back” or otherwise displayed, the recipient end user device must have been in communication with a network control center at least once before such a display is permitted. The network control center then enables the recipient end user device to play back pr otherwise display the received content, for example by sending a code to the recipient end user device. Optionally, the network control center may require payment to be received before enabling the content for the recipient end user device. Thus, the present invention supports flexible distribution of content according to a number of different distribution models, while still preventing unauthorized play back or other display throughout the lifecycle of the digital content item, and optionally enabling assured payments.

According to preferred embodiments of the present invention, there is provided a combination of secure hardware and software to prevent and/or at least retard unauthorized access or “hacking”. In order for access to the distributed content to be controlled, the content itself must be protected, for example by encryption or scrambling. Hereinafter, the term “scrambling” is considered to encompass both encryption, which involves the mathematically determined alteration of content or even only a part thereof to a form which cannot be read without the proper key, and a simpler form of scrambling, which involves the rearrangement of portions of the content, such that the content is only readable when properly rearranged. Indeed, even the simpler forms of scrambling can be effectively performed by altering, or otherwise rendering inaccessible, a small percentage of the overall content, after which the entire unit of content can no longer be displayed. By protecting the content itself, the present invention enables the content to be completely portable, and to be distributed freely, while still ensuring that control of access to the content is maintained by a central authority.

The preferred combination of hardware and software components enables the present invention to most effectively protect access to the content, while still enabling the user to easily and transparently play back, or otherwise display, the content. More preferably, the end user device which is used for the present invention includes a security module, for unscrambling the scrambled content according to a received code. The security module optionally and more preferably features a renewable security submodule, such as a smart card for example. The security module receives the necessary code from the network control center, and is then able to unscramble the received content for play back or other display. Most preferably, the operation of the security module is transparent or substantially transparent to the end user.

The end user device is preferably in communication with a network control center through a network, which could be the Internet for example, but which could also be a cable network and/or satellite communication, for example. Alternatively, the end user device is in communication with the network control center indirectly, for example through the use of a portable storage medium such as a CD-ROM for example, which could optionally be sent to the end user for distribution of content and/or codes, for example.

According to the present invention, there is provided a method for flexible and secure transmission of digital content to an end user device, the method comprising the steps of: (a) providing a control center for controlling access to the digital content by the end user device; (b) transmitting scrambled digital content to a first end user device by a second end user device, such that the second end user device cannot play back the scrambled digital content; (c) connecting the second end user device to the control center; and (d) transmitting a permission message to the second end user device by the control center, such that the second end user device is able to unscramble the scrambled digital content to form unscrambled digital content.

According to yet another embodiment of the present invention, there is provided a method for securing digital content for transmission to an end user device, comprising: (a) providing a control center for controlling access to the digital content by the end user device; (b) transmitting scrambled digital content to the end user device, such that the end user device cannot play back the scrambled digital content; (c) transmitting a PECM (personal ECM) to the end user device by the control center, the PECM being specific to the end user device; and (d) unscrambling the scrambled digital content by the end user device according to the PECM.

According to preferred embodiments of the present invention, the EMM may also be pre-loaded into the end user device at the time of manufacture, for example. Such “pre-loading” is considered to be included within the compass of the present invention, as also being received from the control center, albeit without direct contact between the end user device and the control center over a network, for example.

According to still other embodiments of the present invention, there is provided a secure precision digital to analog converter, comprising: (a) an encryption engine; (b) a digital to analog converter accepting input from the encryption engine for performing digital to analog conversion; and (c) a secure channel for connecting the encryption engine to the digital to analog converter, wherein the encryption engine is physically separated from the digital to analog converter.

According to yet another embodiment of the present invention, there is provided a method for secure transmission of scrambled content to an end user device, the scrambled content being digital data, the method comprising the steps of: (a) transmitting the scrambled content to the end user device; (b) receiving a permission message by the end user device; (c) unscrambling the scrambled content to form unscrambled content as digital aata only after receiving the permission message by the end user device; (d) converting the unscrambled content from digital data to an analog signal, such that steps (b) and (c) are performed immediately before the analog signal is displayed; and (e) displaying the analog signal. Preferably, the end user device includes a secure device, such that steps (b) and (c) are performed within the secure device, with all signals appearing outside the secure device being scrambled.

According to still another embodiment of the present invention, there is provided a secure precision digital to analog converter.

According to another embodiment of the present invention, there is provided a method for securely and precisely converting scrambled data to a final format for display, the steps of the method being performed within a secure device, the method comprising the steps of: (a) completely unscrambling the scrambled data to an unscrambled format of data; and (b) immediately converting the data in the unscrambled format to the final format for display, such that steps (a) and (b) are performed within the secure device, and such that the data in the unscrambled format is inaccessible externally to the secure device.

According to still another embodiment of the present invention, in a system for secure distribution of digital content, the system comprising a control center for distributing at least one key for unscrambling scrambled digital content and an end user device for receiving the scrambled digital content, there is provided a method for providing temporary access to received scrambled digital content, the method comprising the steps of: (a) sending a temporary key from the control center to the end user device, the temporary key being valid for a limited period of time; (b) receiving the scrambled digital content by the end user device; and (c) unscrambling the scrambled digital content by the end user device according to the temporary key, such that the end user device is only permitted to unscramble the scrambled digital content while the temporary key is valid.

Hereinafter, the terms “file”, “portion” or “item”, with regard to digital content, are used interchangeably and refer to any unit of data for such digital content, whether as a functional unit such as a packet for example, or as a conceptual unit such as a television program for example.

Hereinafter, the term “display” refers to any type of playback or playing out of media content data for a user, including but not limited to, the audible production of audio data and the visible production of video data, and combinations thereof.

Hereinafter, the term “network” refers to a connection between any two or more computational or other electronic devices which permits the transmission of data.

Hereinafter, the term “computational device” includes any type of digital instrument which is capable of operating a software program.

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++, Java and Assembly.

In addition, the present invention could be implemented as software, firmware or hardware, or as a combination thereof. For any of these implementations, the functional steps performed by the method could be described as a plurality of instructions performed by a data processor.

U.S. Provisional Application No. 60/174,530, filed on Jan. 5, 2000; and U.S. Provisional Application No. 60/195,032, filed on Apr. 6, 2000, are both hereby incorporated by reference as if fully set forth herein.

Hereinafter, “Applied Cryptography” by Bruce Schneier, John Wiley 2nd ed. 1996, is incorporated by reference as if fully set forth herein, for the teachings regarding cryptography and techniques for implementation thereof.

### BRIEF DESCRIPTION OF THE DRAWINGS

The invention is herein described, by way of example only, with reference to the accompanying drawings, wherein:

FIG. 1 is a schematic block diagram of a background art system;

FIG. 2 shows a flow diagram illustrating the production of the scrambled digital content according to the background art;

FIG. 3 is a schematic block diagram of a system according to the present invention for secure and yet flexible delivery of digital content;

FIG. 4 is a schematic block diagram of a more detailed exemplary version of the system according to FIG. 3;

FIG. 5 is a schematic block diagram of a secure module according to the present invention;

FIG. 6 shows a background art four bit digital to analog converter (DAC);

FIG. 7 shows a modification of an element of FIG. 6 according to the present invention; and

FIG. 8 shows an exemplary secure DAC according to the present invention.

### DESCRIPTION OF THE PREFERRED EMBODIMENTS

The present invention is of a system and a method for flexible, yet secure distribution of digital content items, optionally with an automatic payment mechanism for purchasing such content. The present invention supports the distribution of content to end user devices from one or more central distribution points, as in client-server models and variations thereof, and/or peer-to-peer distribution, for example between end user devices. In addition, the present invention also supports distribution models within either of these mechanisms for unitary distribution, to a specified end user device, or broadcast/multicast distribution, to a plurality of end user devices. In any case, in order for the distributed content to be operative, for example to be “played back” or otherwise displayed, the recipient end user device must have been in communication with a network control center at least once before the content can be so displayed. It should be noted that optionally such contact may be performed at the time of manufacture of the end user device.

The network control center then enables the recipient end user device to play back or otherwise display the received content, for example by sending a code or other permission message to the recipient end user device. Optionally, the network control center may require payment to be received before enabling the content for the recipient end user device. Thus, the present invention supports flexible distribution of content according to a number of different distribution models, while still preventing unauthorized play back or other display throughout the lifecycle of the digital content item, and optionally enabling assured payments.

According to preferred embodiments of the present invention, there is provided a combination of secure hardware and software to prevent and/or at least retard unauthorized access or “hacking”. In order for access to the distributed content to be controlled, the content itself must be protected, for example by encryption or scrambling. Hereinafter, the term “scrambling” is considered to encompass both encryption, which involves the mathematically determined alteration of content to a form which cannot be read without the proper key, and a simpler form of scrambling, which involves the rearrangement of portions of the content, such that the content is only readable when properly rearranged. By protecting the content itself, the present invention enables the content to be completely portable, and to be distributed freely, while still ensuring that control of access to the content is maintained by a central authority.

The security of the content is more preferably provided through several basic rules. First, preferably all digital content is encrypted or otherwise scrambled throughout the system, except when being received by the network control center for distribution to the end user device, and at the last physical point immediately prior to actual physical use (play back or other display of the content) at the end user device. For example, with regard to audio data, that point would be the creation of the analog voltage signal for transmission to the analog amplifiers. The physical construction of the integrated circuits handling the digital content at the end user device is more preferably performed such that decryption or unscrambling of the content is only available at that point and such that “clear” or unscrambled content cannot be transmitted outside of the end user device.

According to preferred embodiments of the present invention, the digital content is scrambled before being transmitted to the end user device by a broadcast unit at the network control center. The scrambled digital content can then preferably only be unscrambled by the end user device with the correct key. The key is preferably distributed through an ECM (control message), which more preferably enables the end user device to create the correct key and as such may be considered to be an example of a permission message. Optionally, the ECM is broadcast to all end user devices, but the particular end user device is more preferably only able to generate the key if this end user device also receives an EMM, or entitlement message, from the network control center. Thus, the key, or information required to generate the key, may optionally be broadcast, while the ability to use such a key is preferably still controlled by the network control center, through the distribution of some type of permission message for example.

Optionally and most preferably, a more permanent key, or at least the ability to generate such a more permanent key, is also distributed by the control center to a particular, individual end user device. Most preferably, this capability is distributed through a PECM (personal ECM), which is received by the end user device from the control center and provides the permanent capability to access the digital content. Optionally and most preferably, the PECM then replaces the ECM, such that only the PECM is then required for access and display of the digital content. The PECM can be considered to be another example of the permission message.

The preferred combination of hardware and software components enables the present invention to most effectively protect access to the content, while still enabling the user to easily and transparently play back, or otherwise display, the content. More preferably, the end user device which is used for the present invention includes a security module, for unscrambling the scrambled content according to a received code. The security module optionally and more preferably features a renewable security submodule, such as a smart card for example. The renewable security submodule is itself preferably secured, such that information contained within this submodule is protected from unauthorized access. The security module receives the necessary code from the network control center, and is then able to unscramble the received content for play back or other display. Most preferably, the operation of the security module is transparent or substantially transparent to the end user.

The end user device is preferably in communication with the network control center through a network, which could be the Internet for example, but which could also be a cable network and/or satellite communication, for example. Alternatively, the end user device is in communication with the network control center indirectly, for example through the use of a portable storage medium such as a CD-ROM for example, which could optionally be sent to the end user for distribution of content and/or codes, for example.

The present invention also preferably encompasses several different business models, for distribution of content and more preferably also for payment for the distributed content. The business rules and data are preferably embodied in the security module. With regard to renewable or removable security modules, optionally such security modules may be “paired” to end user devices, such that the pairing relationship is established either in manufacture of the end user device and renewable security submodule, and/or through a connection to the network control center, or control center for distribution of the digital content. The pairing relationship may optionally be used to prevent the renewable and/or removable security module from being used with other end user devices.

In addition, business rules rights, credits and so forth are preferably maintained at the network control center. Optionally and more preferably, a requirement for periodic connections to the network control center by the end user device allows for synchronization and detection of pirate activity. One of the rules may optionally force the user to establish a connection from the end user device to the control network center on a periodic basis.

The combination of the local security module for the end user device, and the network control center at the central distribution point, enable the end user to more easily purchase or otherwise obtain content items, while still protecting the digital content against unauthorized access. Interpretation of business rules and conditions embodied in these various EMMs, ECMs and PECMs is preferably performed in the security module. The security module more preferably comprises a renewable security submodule, which most preferably is a smartcard, to enable its service in related or unrelated business applications, such as loyalty cards, purchase of non-digital content items, or any other use. For the removable and/or renewable security submodule, there is an option to exchange data between business applications, thus enabling transfer of credit, loyalty points and so forth from one business application to another. Preferably, the system would further feature a smartcard reader for reading the smartcard, which would be separate from the end user device. The data produced by the smartcard is readable by the smartcard reader, including data resulting from the slots, which is more preferably readable as a coded reply. For reasons of security, preferably direct outside readout of data stored on the smartcard is not permitted. Rather, a query received through the reader results in a coded reply.

The principles and operation of the present invention may be better understood with reference to the drawings and the accompanying description.

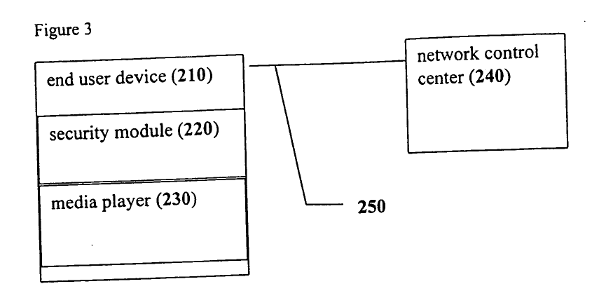

Referring now to the drawings, FIG. 3 is a schematic block diagram of a system according to the present invention for secure and yet flexible delivery of digital content. Although the system is described with regard to audio content, it is understood that this is for the purposes of illustration only and is without any intention of being limiting in any way.

As shown, a system 200 features an end user device 210 with an associated security module 220. End user device 210 also features a media player 230 for playing back or otherwise displaying at least one type of media content, such as audio content for example. End user device 210 is preferably in communication with a network control center 240 through a network 250. Network 250 could be substantially any type of suitable network, including but not limited to, the Internet, a cable network or a satellite distribution mechanism.

Network control center 240 preferably controls access to the distributed content by end user device 210, but more preferably does not solely control distribution of the content. Instead, network control center 240 is preferably capable of distributing content, whether through a broadcast mechanism to a plurality of end user devices 210, or alternatively through a unicast mechanism to a specific end user device 210. In addition, optionally and preferably, end user devices 210 are also capable of direct peer-to-peer distribution of the content. More preferably, network control center 240 does not control such peer-to-peer distribution of content between end user devices 210, but does control access to the distributed content. Such control is preferably provided by requiring an end user device 210 which receives such content to contact network control center 240 before access to the content is possible. Optionally, however, access to a portion of the content may be permitted as “preview” or other introduction before contact is established with network control center 240. For audio content, such a “preview” could optionally include a short length of played back audio data, while for a movie or other lengthier content; such a “preview” could optionally include a longer length of played back content.

More preferably, the distributed content is scrambled before distribution, and can only be accessed by an end user device 210 which possesses the proper code or codes. Most preferably, security module 220 must receive the proper code or codes, and is then able to transparently unscramble the received content for play back or other display of the content. These code(s) can most preferably only be received from network control center 240, thereby enabling network control center 240 to maintain control over access to the distributed content.

Optionally and preferably, different portions of the distributed content are scrambled according to different types of scrambling mechanisms. For example, optionally and preferably, the digital content is encrypted in several parts, each one having a different encryption mode, such that different grades or classes of content are optionally contained within a single unit of content. One example of such a mode could optionally be “clear” or non-scrambled content. Another example is “free viewing”, in which the content may optionally and preferably be scrambled, and is transmitted with an ECM that allows free access to all end user devices 210, and more specifically, to security module 220 of each such end user device 210. Such differential scrambling can optionally and preferably be used to enable a “free preview” function for particular (or all) audiences through their respective end user devices 210, such that the end user could view a portion of the received content in order to determine whether to purchase such content, for example.

According to other preferred embodiments of the present invention, a plurality of different business models for purchasing and managing digital content is supported. Optionally and preferably, there are a plurality of basic distribution models: subscription, rental and “per item” purchase.

For the subscription model, preferably only members of “subscribed” groups are entitled to unscramble, and hence play back or otherwise display, of any digital content earmarked for end user devices 210 of these groups. Again, the subscription enables security module 220 to unscramble the digital content for each such end user device 210. Obtaining a subscription preferably depends on payment of a subscription fee, which may optionally be a single, “one-time” fee, also optionally divided into term payments, or alternatively may only cover a time-limited subscription period. For any type of time-limited subscription, preferably each end user device 210 is only able to access or otherwise use the content for the period of time covered by the subscription, after which end user device 210 would preferably no longer be able to access the content. Such a limit to access by end user device 210 is optionally and more preferably implemented by providing a permission message and/or a code or key which is itself time-limited (as described in greater detail with regard to the implementation of a rental mechanism according to the present invention, for example). The subscription fee may optionally depend on any combination of group and individual subscriber properties, such as group affiliation or membership in other subscription groups for example.

Two special cases of this model are the “All” group case, and “zero subscription fee” case. A combination of these two cases amounts to “free content for all end user devices 210”.

For the second model, rental of digital content items, the access by the end user device may optionally be controlled according to time, number of times that the content item is displayed, or other rental parameters, for example. End user device 210 may optionally and more preferably store such information in a subfield of a purchase slot. This use of the purchase slots limits the number of rented pieces of content an end user device may store at any one time. For example, end user device 210 may optionally first receive a temporary key for accessing the scrambled digital content, which is sent from network control center 240. The temporary key would preferably only be valid for a limited period of time, after which end user device 210 could no longer access the scrambled digital content, unless end user device 210 receives a permanent key. For example, the temporary key could optionally be an ECM, while the permanent key could optionally be a PECM.

For the third model, purchase of individual digital content items, an individual user may optionally and preferably purchase individual items or groups of items, with a variety of purchase mechanisms and methods. For example, the user may optionally be entitled to outright ownership of the digital content item, rental for a given period of time or a given number of renderings for play back or other display, and so forth. The purchase price may optionally be a function of any parameter within the system, including (but not limited to) group membership, other purchases, and time of purchase and/or download.

Both the subscription and “per item” purchase models, optionally with variations, may optionally and preferably co-exist within a single system, with parameters under control of network control center 240 and, to a certain extent, under the control of the user through end user device 210. As previously noted, these parameters are more preferably stored in, and operated by, security module 220 of end user device 210, or more preferably in removable security submodule, such as a smartcard for example (not shown).

It should be noted that both distribution models support superdistribution, in which content is delivered between end user devices 210, rather than being sent from network control center 240, with appropriate payment still being correctly distributed under the control of network control center 240. Superdistribution, copy protection and media transfer, such as recording content in one end user device 210 and attempting to play this content in another end user device 210, are all preferably subject to business rules which are set by network control center 240 for particular content, groups of users at end user devices 210, or individual users at particular end user devices 210.

Another form of superdistribution is for gifts, where the purchaser has paid for the rights and the content is delivered to end user device 210 of another user. One method would be to make the purchase from network control center 240 on behalf of the other end user device 210. Network control center 240 would then send the content and appropriate code for accessing the content to the specific end user device 210 of the other user, and more preferably to security module 220 for that specific end user device 210, or more preferably in the removable security submodule as previously described.

Preferably the following specific distribution modes are implemented for the digital content: free, in which the digital content is optionally not scrambled or encrypted; permitted for decryption or other unscrambling to all valid end user devices 210; permitted for decryption or other unscrambling to end user devices 210 of subscribers, optionally according to their subscription level, for example for a group of subscribers; permitted for decryption or other unscrambling to a group of a plurality of end user devices 210, such as for members of a family for example; and permitted for decryption or other unscrambling to a particular, individual end user device 210. One significant advantage of the present invention is that all of these different distribution modes may optionally be maintained concurrently. Again, most preferably, these different distribution modes involve sending a code and/or other instructions to security module 220 for each end user device 210.

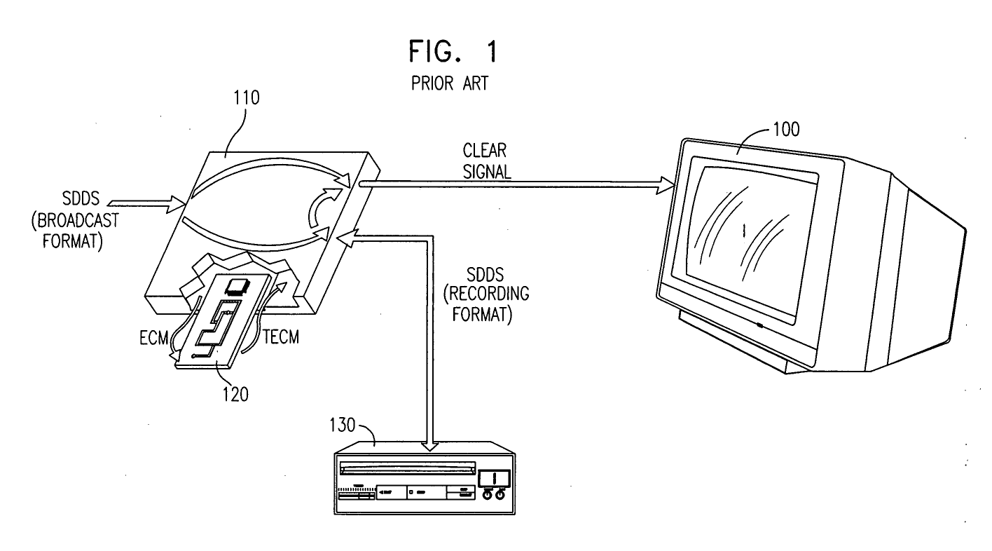

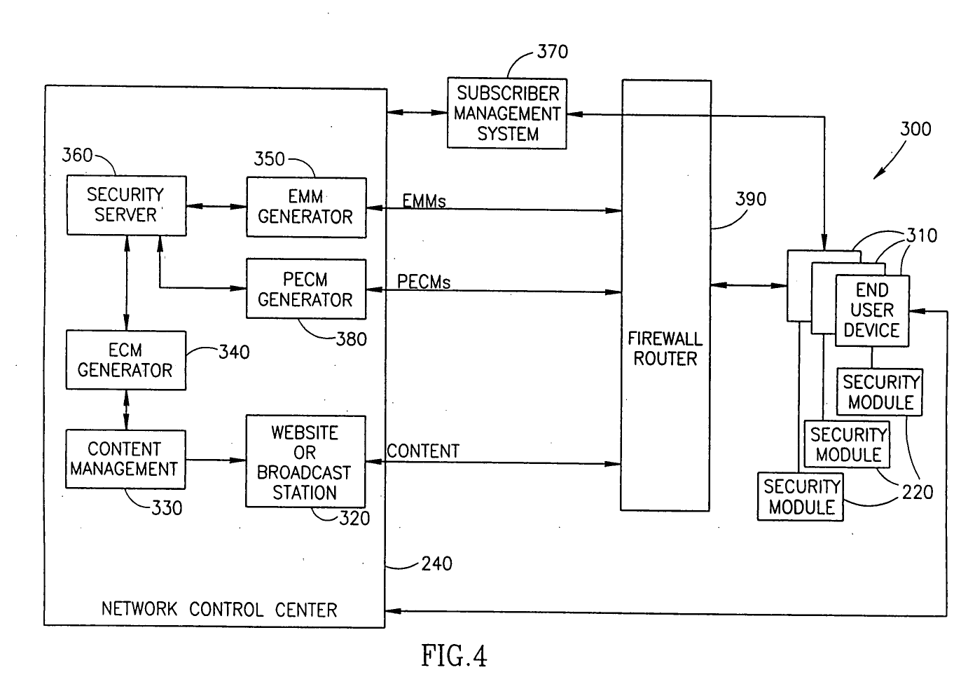

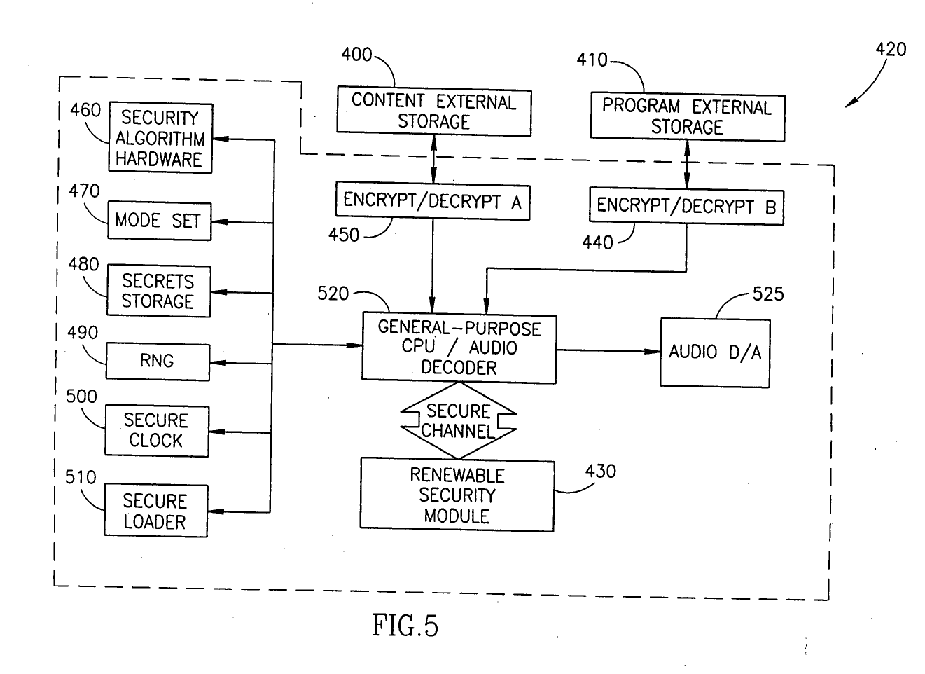

FIG. 4 shows preferred embodiments of the system of FIG. 3 according to the present invention. As shown, a system 300 according to the present invention features an end user device 310, for which a more detailed preferred embodiment is illustrated in FIG. 5 below. Briefly, end user device 310 is able to receive scrambled digital content and to unscramble the received digital content, if end user device 310 is authorized to do so. End user device 310 also preferably features security module 220, as for FIG. 3 above. End user device 310 may also optionally be implemented with a combination of media device 100, IRD 110, and removable security element 120 for security module 220, such as a smart card for example, as shown in background art FIG. 1 above. In this implementation, removable security element 120 is one example of a renewable security submodule, such as a smartcard for example.

Each end user device 310 receives the scrambled digital content from network control center 240, which in this implementation includes all components behind a firewall 390. Control over the distribution of content from network control center 240 is preferably located at a subscriber management system 370, which determines the type of content which can be accessed by each end user device 310 and/or groups of end user devices 310.

Preferably, the content is transmitted by a broadcast unit 320, which is optionally implemented as a cable head end, for example, or alternatively as a Web server for serving Web pages, as another example. The Web server could also optionally serve other types of content as well, such as streaming video content for example, and is particularly preferred example for unicast distribution of content to a single end user device 310. However, preferably, all end user devices 310 receive the same or substantially the same scrambled digital content from broadcast unit 320, regardless of the implementation of broadcast unit 320, such that the digital content can be stated to be broadcast or multicast. Another example for broadcast or multicast distribution is the transmission of digital television data over the appropriate channels. Superdistribution, or content transfer between end user devices 310 for peer-to-peer distribution, may be considered to be a sub-case of unidirectional distribution.

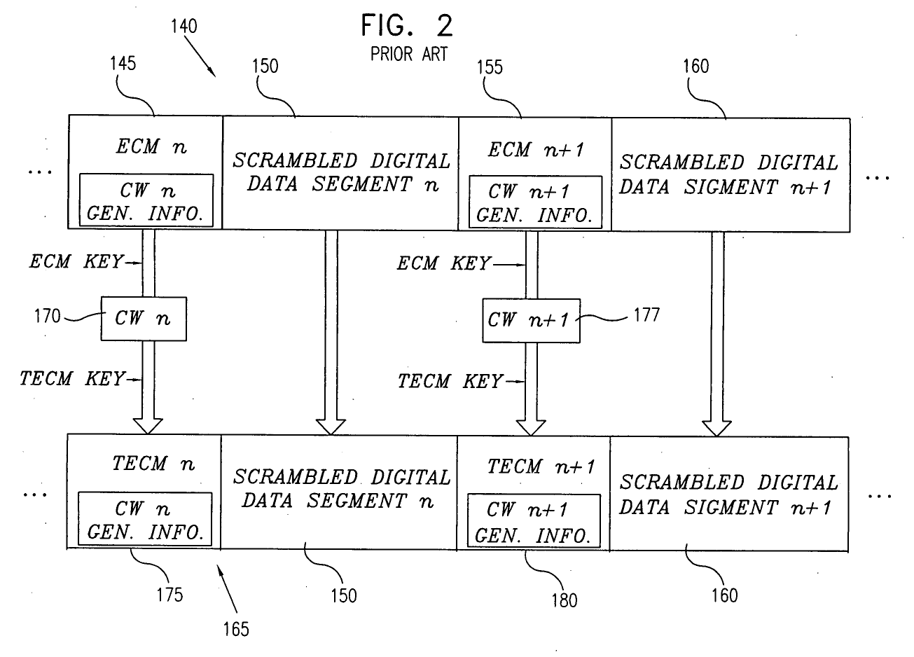

The broadcast digital content is scrambled in order to prevent access by unauthorized users through end user device 310. Preferably, a content management unit 330 scrambles the digital content with an key to form scrambled content. More preferably, the scrambled digital content also features an ECM (entitlement control message), containing coded information for generating a control word in order to unscramble the digital content by end user device 310, for example as described with regard to background art FIGS. 1 and 2 above. Each ECM is preferably generated by an ECM generator 340, which is in communication with content management unit 330 as shown. More preferably, each ECM is also signed, and optionally and most preferably, is also encrypted.

Producing a key from the ECM, with which to scramble the distributed content, is more preferably performed through some type of one-way function, which most preferably receives at least a portion of the required input from the ECM. This one-way function is also most preferably shared by ECM generator 340 and security module 220, yet is also preferably only known ECM generator 340 and security module 220 as a shared secret. Examples of suitable one-way functions are well known in the art (see for example the previously incorporated “Applied Cryptography” by Bruce Schneier, John Wiley 2nd ed. 1996).

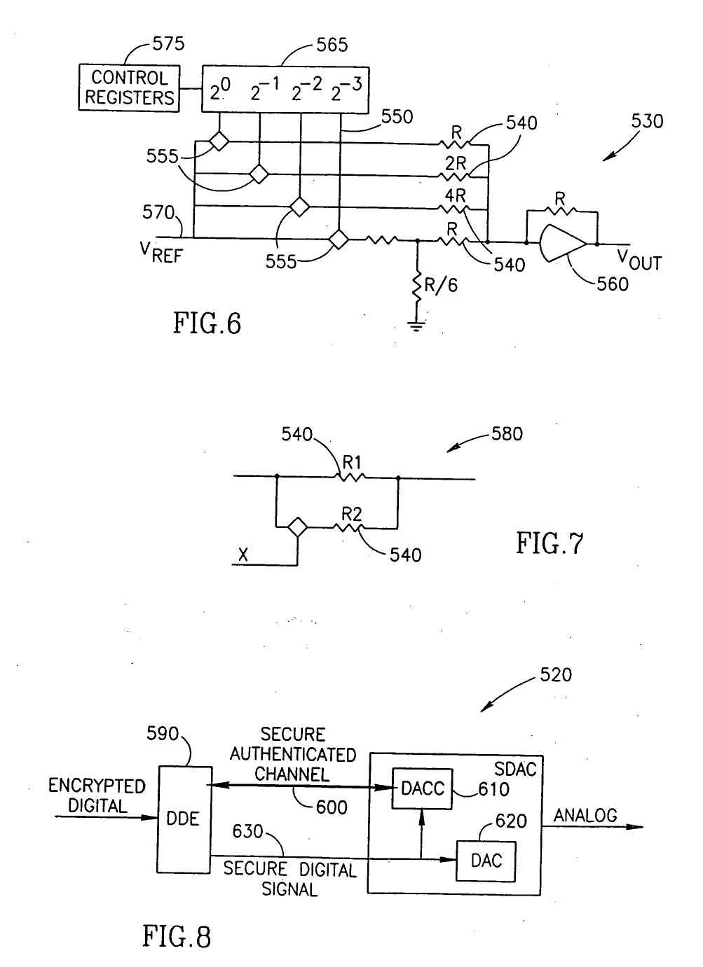

According to preferred embodiments of the present invention, content management unit 330 encrypts and/or scrambles, optionally “off-line” rather than on-demand or in “real time”, all digital content files with a control word provided by ECM Generator 340. Control management unit 330 may optionally then embed the actual ECM within the content. The control word is preferably derivable from the ECM using a method such as encryption or a one-way function as determined by security server 360. In addition, security server 360 optionally contains a security mechanism with a replaceable algorithm synchronized with security module 220 in end user device 310, as described in greater detail below with regard to FIG. 6. Again, a preferred embodiment of security module 220, or at least a preferred feature thereof, is a renewable security submodule, such as a smartcard for example (not shown). The renewable security submodule is itself preferably secured, such that information contained within this submodule is protected from unauthorized access.

Preferably, system 300 is implemented using two-tier encryption. The digital content to be delivered is optionally first encrypted by a “strong” algorithm A (for example, 3DES), while the key (or control word) for that particular algorithm is preferably encrypted by using one of several more time-consuming algorithms, according to the intended purpose of the particular piece.

The scrambling and/or encryption key or keys, preferably together with the metadata describing the content and its intended uses through the previously described ECM, are more preferably delivered in encrypted and signed packet(s), optionally together with the content, to end user device 310. The whole message (content, keys and metadata) is more preferably signed, optionally using message digest or other special methods for efficiency of processing, to prevent message changing.

According to preferred embodiments of the present invention, each ECM is also broadcast with the broadcast scrambled digital content by network control center 240. However, each end user device 310, and more preferably security module 220, is only able to use the ECM to generate the control word, or otherwise to unscramble the scrambled digital content, according to some type of authorization. Again, as previously described, more preferably the renewable security submodule component of security module 220 performs the generation of the control word, or otherwise unscrambles the digital content according to the authorization.

Preferably, the authorization is determined automatically by security module 220 of end user device 310 according to one or more EMMs (entitlement management messages), which optionally and more preferably are directed specifically to a particular end user device 310, or at least to a class or group of such end user devices 310. Each EMM determines the entitlement or “rights” of any particular end user device 310, and/or of security module 220 for any such end user device 310, to unscramble the scrambled digital content, more preferably by determining access to the coded information in the ECM. Each EMM is preferably created and transmitted by an EMM generator 350, and may optionally be delivered separately or together with the scrambled digital content. More preferably, each EMM is signed by a security server 360, for example at the time of creation of the particular EMM. Security server 360 also preferably creates keys with a high degree of randomization, and also signs control messages (such as ECMs and EMMs).

Optionally and most preferably, security module 220 of end user device 310, and particularly most preferably the renewable security submodule thereof (not shown), compares at least one requirement in the received ECM to at least one entitlement in one or more of the received EMMs, to determine if there is a sufficient match. If so, security module 220 of end user device 310 then preferably automatically proceeds to derive the required coded information in the received ECM for unscrambling the scrambled digital content. If there is not a sufficient match, then end user device 310 preferably cannot immediately unscramble the digital content, but optionally may apply to a subscriber management system 370 for receiving the EMM, as described in greater detail below.

Each EMM is delivered in packets which may optionally be delivered either separately or together with a given content package (scrambled digital content). EMMs are more preferably encrypted and/or signed for use by an individual end user device 310 and/or by a group of such end user devices 310.

According to preferred embodiments of the present invention, system 300 also features a PECM generator 380 for generating a PECM (Personal ECM). Each PECM that is associated with a given file or portion of digital content preferably generates the same control word for that given digital content. However, preferably only a particular end user device 310, and more preferably security module 220 of such a particular end user device 310, is able to generate the control word from the associated PECM, such that passing the PECM to a different end user device 310 preferably does not enable such a different end user device 310, and/or security module 220 of such a different end user device 310, to generate the clear, unscrambled digital content for play back or other types of display. Each PECM is also optionally and preferably signed by security server 360.

The preferred feature of the PECM optionally and preferably enables a user to purchase, use and optionally and more preferably record, a plurality of different files or portions of digital content. Indeed, the PECM enables end user device 310 to support an almost unlimited number of such files or portions of digital content. Each PECM is preferably sent to a particular end user device 310, and is then persistently stored at that end user device 310, more preferably in association with the digital content that is unscrambled, decrypted or otherwise unlocked with that PECM. Furthermore, this particular implementation of the PECM according to the present invention is not taught by the background art, as it combines the provision of permanent storage at end user device 310 with personalized unscrambling through communication with a central authority, in this case network control center 240. Background methods for permanent storage through end user device 310, such as those taught by European Patent Application No. EP 0858184 for example, do not include such a requirement for communication with a central authority.

End user device 310 preferably replaces one or more ECMs, which are preferably transient and locked into a particular configuration on end user device 310, with one or more PECMs which are also as secure but which act autonomously. More preferably, such a replacement process occurs when end user device 310 connects to subscriber management system 370, or alternatively to PECM generator 380. In any case, if the replacement process occurs through subscriber management system 370, subscriber management system 370 should have a database (not shown) of end user devices 310 for which PECMs have been requested and generated, but not yet delivered. Hence, this connection may optionally effectively restore the number of content items that the user may purchase and store on end user device 310, thereby enabling the user to order more such items.

According to preferred embodiments of the present invention, a number of different components of network control center 240 may optionally operate in conjunction in order for permanent storage of the content to be effected through the PECM. For example, the content, the ECM, the EMM and even the PECM could all optionally be distributed by broadcast unit 320. However, optionally and preferably only the content is distributed by broadcast unit 320. Optionally, ECM generator 340 distributes the ECM, PECM generator 380 distributes the PECM and EMM generator 350 distributes the EMM. More preferably, each type of message is sent from the respective generator to subscriber management system 370, which then distributes the message to the correct end user device 310. Most preferably, the ECM is distributed with the content by broadcast unit 320, while the EMM and the PECM are distributed by subscriber management system 370.

The use of PECM's overcomes a number of problems with background art content distribution mechanisms, as they enable permanent storage at an end user device 310 to be performed while still giving control to a central authority such as network control center 240, for example. The requirement for permanent storage results from a typical limitation of end user devices 310, and more specifically of security modules 220. Briefly, security module 220 preferably features a secure storage memory for storing such information as records of purchases of content, more preferably featured in the renewable security submodule (not shown), such as a smartcard for example. For greater rapidity of access, more preferably the secure storage memory is implemented as a plurality of purchase slots, each of which holds the record for a particular purchase (for example, by being associated with a particular ECM). Such purchase slots are known in the art for various types of content purchases through a network, such as for “pay television” for example. However, they have the clear disadvantage of being limited on end user device 310, or indeed for any other type of device, and therefore may become filled. Thus, clearing these purchase slots enables more purchases to be performed and recorded on the purchase slots.

In order for the purchase slots to be cleared, preferably end user device 310 must receive the PECM, such that end user device 310 more preferably should connect repeatedly to network control center 240 for such PECM's. As soon as the PECM is received by end user device 310, preferably the relevant purchase slot is cleared of the corresponding ECM and/or the associated information, such that the PECM preferably replaces the ECM at end user device 310. More preferably, only the PECM is required by end user device 310 for access to, and display of, the digital content.

Two possible frameworks for ensuring repeated connection from end user device 310 to PECM generator 380. In the unicast domain, for example if broadcast unit 320 is implemented as a Web server, end user device 310 may optionally be forced to connect periodically to fetch EMMs and PECMs. In the broadcast domain, end user device 310 may optionally display a purchase meter (similar to the battery meter on laptop computers), which denotes the number of purchases remaining. When only a few purchase slots are remaining, the user may choose to reconnect end user device 310 to PECM generator 380 to reset the purchase meter to the maximum number of available purchase slots by replacing each corresponding ECM at a purchase slot by the relevant PECM, such that each cleared purchase slot can then potentially hold a file or a record of a purchase of digital content (see FIG. 5 below for an explanation of such purchase slots).

According to preferred embodiments of this implementation of system 300, as previously described, the original ECM optionally and preferably remains attached to the encrypted or otherwise scrambled digital content even after receipt of the PECM. This preferred embodiment is very important if the purchased digital content, together with attached ECMs and PECMs, are copied to another end user device 310. The second end user device 310 would not be able to use the attached PECM, since this PECM is specific for the first end user device 310. The second end user device 310 would then recognize the PECM as such, attempt to verify the PECM for unscrambling the digital content, and would then determine that the PECM is invalid for that end user device 310. Next, the second end user device 310 would attempt to retrieve the embedded ECM and would then optionally perform various actions as indicated, for example by attempting to purchase the digital content from broadcast unit 320, as described in greater detail below. In effect, this process results in superdistribution, wherein end user devices 310 themselves distribute the content, with subscriber management system 370 simply collecting the payment and reconciling accounts. However, it should be noted that the preferred requirement for maintaining the attachment of the ECM to the digital content is more preferably only intended to support superdistribution, such that the first end user device 310, for which the PECM is relevant, preferably does not need to retain the ECM in order to access the digital content once the PECM has been received.

According to preferred embodiments of the present invention, in order to support “peer-to-peer” distribution or superdistribution between end user devices 310, more preferably an end user device 310 which receives such content through this form of distribution also receives information about which network control center 240 should be contacted in order to obtain the requisite code or other permission message. Assuming that more than one such network control center 240 exists, more preferably the recipient end user device 310 either contacts such a network control center 240 which is the “regular” or “home” network control center 240 for that end user device 310, or receives an address for the correct network control center 240 to be contacted for receiving the permission message. Such an address is optionally embedded in the ECM which is sent with the content itself.

According to other preferred embodiments of the present invention, the use of such entitlement messages supports a plurality of different business models for purchasing and managing digital content.

With regard to specific implementations with the entitlement message mechanism of the present invention, preferably the following specific distribution modes are implemented for the digital content: free, in which the digital content is optionally not scrambled or encrypted; permitted for decryption or other unscrambling to all valid end user devices 310; permitted for decryption or other unscrambling to end user devices 310 of subscribers, optionally according to their subscription level, for example for a group of subscribers; and permitted for decryption or other unscrambling to a particular, individual end user device 310. Again, most preferably, these different modes are actually supported by, and performed at, security module 220 of end user device 310.

Each EMM supports these different distribution models by optionally authorizing each end user to receive free and/or subscription digital content, or to purchase paid “per item” digital content. This support is preferably accomplished by sending a CA Service ID that identifies the rights to a particular content item to each end user device 310. End user device 310 then compares the CA service ID to such an ID of the digital content item as the digital content item is received.

For example, for free content, an EMM containing a common CA service ID is preferably distributed to all valid end user devices 310. For subscription content, an EMM containing a specific CA Service ID is preferably delivered to end user devices 310 of all users who have subscribed to a particular service. The CA Service ID corresponds to the particular service which has been ordered through a subscription to subscriber management system 370. Preferably, each unit of content delivered through the service has a specific CA Service ID for identifying that unit of content, which could optionally include for example, an identifier for identifying the particular subscription service generally and another identifier for identifying the specific unit in particular.

For paid “per item” digital content, a EMM containing a particular CA Service ID is preferably sent to end user devices 310 of all users who are authorized to purchase this item.

For the superdistribution model and/or automated purchase of “per item” content, preferably the ECM is embedded in the digital content, and includes information related to the fact that this digital content is purchasable. In addition, the ECM also more preferably contains both the unique ID (identifier) for that paid content and a CA service identifier for the group which is allowed to receive this paid content. The embedded ECM also preferably includes all of the information necessary to determine the price and business model(s) which applies to that purchase: for instance, rental duration and associated pricing, number of renderings and associated pricing and/or price for outright ownership.

For superdistribution and/or per item purchase, preferably a preview portion may be freely played back or otherwise displayed, according to the same mechanism as for rendering the paid content. However, upon reaching the ECM in the digital content which requires payment, the end user is more preferably required to purchase this content through some user friendly interface, such as a purchase button or other GUI gadget of end user device 310 for example. If authorized, upon purchase, end user device 310 securely marks this purchase, for example by marking a purchase slot containing the unique ID of the content concatenated with a unique ID of end user device 310 and/or of security module 220, and/or of renewable security submodule within security module 220 (see FIG. 5 below for an explanation). Upon play back or other display of this content after purchase, end user device 310 compares the unique content ID contained in the ECM of the digital content and the unique ID of end user device 310, with the contents of the slots stored. If there is a match, the digital content is decrypted and rendered at the analog output.

This business model and technology is further supported through the optional but preferred provision of a sharing capability between members of a “family”, whether actual or created for the purposes of sharing content between a plurality of specific end user devices 310. In order for such sharing to be enabled, preferably a plurality of secure tokens, such as smartcards for example, are provided for deciphering PECMs encrypted to a common public key. Therefore, members of this group of end user devices 310 are all able to read the PECMs for the group. These tokens are designated “family members”, and are associated with a particular group of end user devices 310. With regard to the business model, more preferably end user devices 310 which belong to a family are therefore able to share digital content.

New end user devices 310 may optionally be added into a family, by creation of a secure channel between a current family member end user device 310 and a new family member end user device 310 through a secure device, or optionally through an on-line facility such as by communication with network control center 240. For direct “peer-to-peer” communication through the secure channel, preferably such a channel is implemented through encryption with a handshake procedure. In this handshake procedure, more preferably a part of a secret key is exchanged by each end user device 310 involved in the handshake procedure.

On the other hand, in order to prevent unlimited proliferation of family members and/or of shared content between such members, such members and/or such shared content are preferably limited according to one or more “reasonableness rules”. Many implementations of such rules are possible within the scope of the present invention. For example, there can optionally be a limit on the number of family members to which a token may belong. Also, generation marking within the tokens is optionally possible. There may also optionally be duplication limits for time, number of times content is played, and for cumulative play time for the content items. For example, a family member might only be able to make a certain number of copies of content, and/or might be restricted according to a period of time and/or end user device 310 activity between different instances of sharing of copies. More preferably, stricter limitations are placed on “second generation” family members which receive tokens and/or content from another family member. Family tokens may also optionally be registered in database, each having a unique ID. There may also optionally be an override of duplication limits, for example through communication with network control center 240 generally or subscription management system 370 specifically. Again, all of these different security functions at end user device 310 are preferably performed by security module 220, and more preferably are performed by the renewable security submodule, as explained in greater detail below. These rules and security functions are intended to prevent commercially viable, illicit copying and distribution of content.

As shown with regard to FIG. 5 below, the management of entitlements, for example through one or more of addition, removal, invalidation, and status polling thereof, is preferably performed on a separate, secure “renewable” means of storage and computation, such as a smartcard, which comprises a component of security module 220. Thus the entitlements may be delivered via several paths, including those mechanisms that do not involve the play back or display functions of end user device 310 directly, for example when performed by separate payments.

As shown, a portion of end user device 310 features various security components, in addition to a content external storage device 400 and a program external storage device 410. Content external storage device 400 stores the digital content which has been received by end user device 310. Program external storage device 410 stores instructions for operating end user device 310. Both content external storage device 400 and program external storage device 410 preferably operate such that unencrypted content is not present outside of end user device 310. More preferably, in the implementation in which the components of FIG. 5 are constructed in a single chip, the unencrypted or unscrambled content should not be present outside of such a single chip. Thus, external content memory in content external storage device 400 is encrypted (or scrambled), unencrypted data busses do not extend off-chip, and digital-to-analog conversion (D/A) is preferably performed on-chip.

The remaining components of end user device 310 which are shown in FIG. 5 are intended for security, and together form a security module 420. Preferably, security module 420 features a renewable and/or removable security submodule 430, which could be a smart card for example. Security module 420 may optionally and preferably prevent end user device 310 from operating if renewable security submodule 430 is not present, for example through communication according to software program instructions between renewable security submodule 430 and end user device 310. In addition, renewable security submodule 430 may also optionally and more preferably be constrained from operating with any other end user device 310.

Since the content decoding algorithms (as well as the decryption algorithms) may change over time, at least a part of the program instructions are preferably downloadable to program external storage device 410. Any program that can access any of the security-related software or data must not be amenable to a change by non-authorized users. Such program instructions must therefore preferably be loaded only through a secure loader, requiring knowledge of secret passwords and procedures. More preferably, such a process of loading the program instructions is performed through a Zero Knowledge Test—type authentication, such as Fiat-Shamir, as described for example with regard to U.S. Pat. Nos. 4,748,668 and 4,933,970, which are hereby incorporated by reference as if fully set forth herein.

External program memory in program external storage device 410, and a bus 440 connecting program external storage device 410 to security module 420, are preferably encrypted to deter unauthorized users from reading the program instructions. Also preferably, external content memory in content external storage device 400, and a bus 450 connecting content external storage device 400 to security module 420, are encrypted to deter unauthorized users from accessing the content. Since the encryption scheme and/or keyword for the content memory are more amenable to analysis than that of the more-critical program memory, the two schemes (or at least their keywords) more preferably differ.

In addition, more preferably each individual end user device 310 has an individual set of keywords, so that bus readout on two different end user devices 310 from busses 440 and/or 450, would yield different results. This result may optionally be achieved by generating random keywords for each end user device 310 by final test machinery during production, and then burning-in these keywords into on-chip persistent memory at a secure storage 480 (see below for description in greater detail). Another option involves having a true random number generator on-board, generating random keywords

On-chip keyword generation is especially attractive if battery-backup volatile external memory is used, similar to the scheme used by Dallas Semiconductor Corp. (USA) for their “Soft Micro” line of secure microcontrollers (see for example the “Soft Microcontroller Data Book” from Dallas Semiconductor Corp.). These secure microcontrollers feature an external memory in which data is stored in an encrypted format, while the central processing unit stores the key for decrypting the encrypted data in a secure non-volatile storage which cannot be externally accessed. Therefore, the data remains protected. Each time new program information is to be loaded into the external memory, a random number generator which is associated with the central processing unit generates a random number, which then becomes the key for encrypting the data. These microcontrollers also have various firmware security features, for protecting the stored key.

In any event, keywords and other “secret” information must be stored on-chip, to avoid exposure to “line sniffing” or access by reading a bus from outside the chip.

In addition, as shown in FIG. 5, security module 420 features an internal memory 460 for storing instructions for executing security algorithms, for example in order to accelerate certain computations such as DES or modulo arithmetic. Security module 420 also optionally and preferably features a mode set 470, including mode set logic and hardware, which enables the same basic chipset to serve the varying requirements of system vendors. A typical implementation would contain one-time memory elements (OTP) or fuses, to force a particular chip into certain modes for providing different customers with different facilities, such as higher security to those customers who wish to pay for such higher security. The OTP and/or fuses could also optionally be used for a secret identifier for a particular chip.

An optional additional memory is secure memory 480, for storing keywords and other secret information which is required for the operation of security module 420. Secure memory 480 also optionally features a plurality of purchase slots, which are locations for holding the record of purchase for particular content. Alternatively and preferably, the plurality of purchase slots are maintained at renewable security submodule 430. Each such slot can be rapidly accessed for recording the purchase. However, one disadvantage of using purchase slots is that they can become filled with the recorded purchases. The use of PECM control messages according to the present invention helps to overcome such a limitation on the number of slots. Alternatively, the purchase slots may also optionally be located at content external storage 400 and/or program external storage 410.

Also, a random number generator 490 may also optionally be included, for generating random numbers in order to perform various security procedures. For example, as previously described, random number generator 490 may optionally be used for generating random numbers as keys for encrypting data for storage at content external storage 400 and/or program external storage 410.

Optionally and more preferably, security module 420 also features a secure clock 500. At the very least, secure clock 500 may actually optionally be implemented as a secure with specialized logic to prevent any decrementing or incrementing, or at least to prevent an untoward amount of such decrementing or incrementing, as at least a certain amount of alterations to the clock may occur through user error, for example. More preferably, secure clock 500 features a non-volatile internal memory with additional clock security to prevent unauthorized access, such that the clock cannot be reset to an earlier (or future) date to obtain some time—dependent rights.

Another optional but preferred component of security module 420 is a secure loader 510, for loading new program instructions to program external storage device 410 for example. Secure loader 510 is more preferably implemented with a memory for storing instructions for performing a Zero Knowledge Test—type authentication, such as Fiat-Shamir for example, as previously described.

According to preferred embodiments of the present invention, the digital content is stored in an encrypted or scrambled form in content external storage device 400, and is maintained in this form until the last possible physical and functional point before the content is played back or otherwise displayed to the user. Preferably, this last point occurs when the digital data is converted to a signal, for example when audio data is converted to the analog signal form for being played back through analog speakers to produce music or other sound.

In order to support decryption or unscrambling of this digital content at that point, the present invention preferably features a Secure Digital to Analog Converter (SDAC) 520, an exemplary implementation of which is shown with regard to the schematic block diagrams of FIGS. 6-8. With SDAC 520, any “sniffing” of the digital line or lines between the content unscrambler and an analog output device 525 would yield commercially unusable noise or severely distorted signal. The present invention therefore provides a secure device in which the scrambled content is unscrambled at the last physical point before “play back” or other display of the content. For example, for audio data, this last physical point occurs as the digital data is converted to an analog signal for play back. The present invention is able to perform such a conversion securely, such that the unscrambled content is not accessible outside of the secure device.

The current main obstacle to constructing a secure device that does not present any digital output of the unscrambled (“clear”) content on any external lines stems from the current state of technology. High quality music reproduction, for example, requires about 24-bit resolution Digital to Analog Converters (DACs). Real-time decryption and decoding of encrypted compressed music files requires high processing power CPU, which is provided by the Decryption/Decompression Engine, or DDE. Placing these two components together on a single piece of silicon so that no clear digital data is available on exposed interchip lines results in coupling DDE electrical noise into the DAC analog output to a degree that results in unacceptable audio quality.

For this reason, all currently available background art high-quality DACs are built into chips (integrated circuits) that are physically separate from the high-speed CPU's. The result is that lines from DDE's to DACs carry clear digital content data, which correspond to the actual data, whether audio or other types of data. These insecure lines can be “sniffed” to extract the clear digital data. Thus, the background art relies upon separation of the decryption engine from the digital to analog converter component, in order to overcome the problem of excess noise generation.

FIG. 6 shows a typical four bit digital to analog converter (DAC) 530 according to the background art, featuring a plurality of resistors 540 and resistor ladder elements 550, or branches, to each of which a reference voltage is applied through an electronic switch 555. Each branch output voltage is zero if the corresponding switch 555 is open, and a certain (fixed) value in case it is closed. These voltages are summed in an amplifier 560 to produce the DAC output voltage for DAC 530. A “Single-Sided” DAC (that is, 0 to Vmax volts output, rather than ±Vmax) is shown for convenience, without the numerous auxiliary circuits involved.

DAC 530 also includes an input digital interface 565, which may optionally be implemented as parallel or serial, in any of several standard formats which are known to one of ordinary skill in the art, which accepts digital values to be converted. An input digital value is defined by a number of binary digits (bits), each of which may be either “0” or “1”. Input digital interface 565 directs each of these bits to the appropriate switch 555. Input digital interface 565 also preferably features a plurality of control registers 575 for controlling input to input digital interface 565.

Resistors 540 are adjusted so that each branch produces a binary-weighted voltage value corresponding to the binary position of the bit that actuates switch 555 for the branch. Binary weighted resistors 540 are preferred for the precision weighing resistors since any number of such weighted resistors 540 can then optionally and preferably be combined in sequence. Thus the sum of these voltages seen at output amplifier 560 is equal to a reference voltage 570 times the input digital value.

Conventionally, the relative “weights” of the various bits of the combination of resistors 540 and switches 555 of DAC 530 correspond to integral powers of two, such that the output voltage value corresponds exactly to the input binary word, except for the effects of (unwanted) non-linearities, noise and other undesirable effects. Thus, the ideal analog output voltage value corresponding to a N-bit digital input X is Vref*Σᵢ {2⁻ⁱ*Xᵢ}, where i is the position of binary digit within the input word (from 1 to N), Xi is the value of the i-th binary digit (0 or 1), and Vref is the DAC reference voltage. This input/output relationship is known, linear and constant.

Non-linear DACs exist for special applications such as extending the output range without loss of resolution over a limited sub-range. In such DACs the relationship between the digital input word and the voltage output follows a non-linear function, but that function is known and constant, and in line with required accuracy.

Another conventional DAC form is the “one-bit” DAC, or more accurately “delta-sigma modulator with one bit DAC”, as shown with regard to FIG. 7. A one-bit DAC 580 produces an analog voltage value by generating a high-frequency waveform whose instantaneous values are one of either of two known fixed numbers, through one of two resistors 540. These numbers (“step-up” and “step down”), are conveniently designated “0” and “1”, but quite often are opposite-polarity, equal-amplitude values. The waveform averages, through a suitable filter, to the required instantaneous voltage.

To reduce DAC output noise, it is important to keep the number of high-speed switches within the converter chip to a minimum, and have the necessary switching done in a synchronous manner. Similar considerations apply when the digital input to the DAC chip is serial rather than the parallel scheme just described.

In order to provide a fully secure DAC, SDAC 520 (shown in FIG. 8) according to the present invention includes a number of features which are not implemented in the background art, thereby improving on the functionality of the two DAC implementations of FIGS. 6 and 7. First, the encrypted or scrambled digital content is received by a Decryption/Decompression Engine (DDE) 590, which could optionally be security module 420, for decrypting or otherwise unscrambling the digital content, as previously described. Of course, SDAC 520 could also optionally be used with other types of content processors. DDE 590 is connected to SDAC 520 through a secure authenticated channel 600, which preferably is directly in communication with a CPU/cryptographic engine (DACC) 610. More preferably, both parts of the SDAC 520 (DACC 610 and DAC 620) are on the same chip, for security reasons. However, in order to avoid CPU-related noise effects, DACC 610 is preferably used only at low speed (or not at all) during the digital to analog conversion process as performed by a DAC 620, thereby avoiding degradation of DAC performance. Thus, the present invention avoids the drawbacks of the background art by separating the operation of the decryption engine from the operation of the digital to analog converter in time, rather than in space, as for the background art.

Although DAC 620 itself may optionally be implemented according to any one of a number of different background art implementations, the input-output transfer function of DAC 620 is settable by DACC 610. The settings are so designed that there is no (or minimal) asynchronous switching during use. The variety of settings is such that it would be extremely difficult to extract the original (binary-weighted) digital word corresponding to an output voltage, given a limited number of observed SDAC digital inputs and analog output voltage measurement.

According to preferred embodiments of SDAC 520, secure authenticated channel 600 is established between DACC 610 and DDE 590 through a cryptographic mechanism, in which DACC 610 and DDE 590 exchange keys, during a short “setup session” at the beginning of a play back period. Such cryptographic mechanisms are known in the art and could easily be implemented by one of ordinary skill in the art (see for example “Applied Cryptography” by Bruce Schneier, John Wiley 2nd ed. 1996, particularly AKE: authenticated key exchange in Chapter 3 pg 47; and “Handbook of Applied Cryptography” by A. Menezes, P. Oorchot, and S. A. Vanstore, CRC Press, 1997, particularly Secure Channel on pg. 13, and AKE in Chapter 12 pg 489). No content is played during the setup session, so DACC 610 can be in full operation and negotiate the transfer function parameters for the upcoming play back period without any noise effect on DAC 620. Conversely, full-speed operation of DACC 610 is not required during the play back period when DAC 620 is performing its main function of digital to analog conversion, as previously described. Thus, the functionality of DACC 610 and DAC 620 are separated in time rather than in space.

The actual digital data is then preferably transferred through a digital signal channel 630, which although shown separately from secure authenticated channel 600 in FIG. 8, may optionally actually share the same physical lines. Typically, secure authenticated channel 600 is initiated by DDE 590.

Once secure authenticated channel 600 is established, DACC 610 preferably proposes a randomly selected set of SDAC parameters. One example of such parameters is the differential weighting of resistors 540 (see FIGS. 6 and 7) according to a non-linear function, which could optionally be performed with any number of such resistors 540, even for a linear one-up/one-down system, as for FIG. 7 for example, as described in greater detail below. The weights would then optionally be chosen as the SDAC parameters. These parameters are preferably different for each pair of DDE 590 and DACC 610, and more preferably are different for each unscrambling operation of DDE 590 and DACC 610. However, it should be noted that the distribution of scrambled digital content is preferably performed such that all end user devices receive exactly the same scrambled content, to preserve distribution bandwidth. These two goals are preferably achieved by having DDE 590 first unscramble the received, scrambled digital content, and then rescramble the digital content according to the different set of parameters which had been established with DACC 610.

Once accepted, both DDE 590 and DACC 610 use the same set of parameters to achieve an overall linear transfer function. On the source side for DDE 590, these parameters are used to modify the binary words transmitted to SDAC 520 for play back. The modification may optionally be carried either in the DDE software (DAC driver) in DDE 590 or alternatively or additionally in special-purpose hardware.

On the receiving side for SDAC 520, DACC 610 sets registers to control the operation of DAC 620, and than preferably effectively shuts itself off. Alternatively, DACC 610 may go into a reduced mode of operation so that its spurious (noise) effects on DAC 620 are within acceptable limits.

Control registers 575 for DAC 620 may optionally and preferably affect DAC operation according to any of the following combinations, and variations, as determined by the received parameters as previously described. For example, the bit order of the input word can optionally be shuffled. For a 24-bit DAC, the number of combinations is on the order of 10²³. In addition, non-binary weighted resistor values can optionally be used, as shown with regard to FIG. 7, to create non-linear converter bit “weights”. It should be noted that since the binary weight scheme is the most efficient, the number of bits in the non-binary-weighted converter must be increased to cover the same range. At the same time, rather small deviations from correct binary weights (due to resistor 540 R2 in the example given) may cause enough distortion to make the content commercially unusable. Small deviations lead to a small number of additional bits required, and minimize requirements on the deviation resistor and/or switch.

As another example, simple cryptographic functions may optionally be used, which may be achieved by any number of methods that do not impose excessive noise on the analog output. For example, an XOR operation can optionally be performed with the output of a Linear Feedback Shift Register.

Furthermore, although SDAC 520 is described in terms of a parallel DAC architecture, the same principle can be applied to any other DAC type. In particular, application of non-binary weighted resistor values to a one-bit DAC may be achieved by using unequal step-up and the step-down voltages.

Also, ancillary functions like calibration, control, inter-chip bus structure and standards, unprotected operation modes, and handling element inaccuracy have not been described, as these elements are well known in the art and could easily be implemented by one of ordinary skill in the art.

While the invention has been described with respect to a limited number of embodiments, it will be appreciated that many variations, modifications and other applications of the invention may be made.

1-83. (canceled)

84. A method for unscrambling scrambled content before display, the scrambled content being digital data and the unscrambled content being displayed as an analog signal, the method comprising the steps of:
(a) unscrambling the scrambled content to form unscrambled content as digital data;
(b) converting said unscrambled content from digital data to an analog signal, such that steps (a) and (b) are performed immediately before said analog signal is displayed; and
(c) displaying said analog signal;
wherein steps (a) and (b) are performed at physically separated locations connected by a secure channel.

85. A secure precision digital to analog converter, comprising:
(a) an encryption engine;
(b) a digital to analog converter for accepting input from said encryption engine for performing digital to analog conversion, said input including encrypted digital content and a key for decrypting said encrypted digital content; and
(c) a secure channel for connecting said encryption engine to said digital to analog converter, wherein said encryption engine is physically separated from said digital to analog converter.

86. The converter of claim 85, wherein said digital to analog converter further comprises:
(i) a plurality of weighted resistors; and
(ii) a plurality of control registers for controlling a weight of each resistor, said plurality of control registers determining said weight according to said key.

87. The converter of claim 86, wherein at least one weight of said weighted resistors is a fractional weight.

88. The converter of claim 87, further comprising an additional channel for transferring said encrypted digital content, such that said secure channel transfers said key.

89. The converter of claim 88, wherein said additional channel and said secure channel share identical physical lines.

90. A method for secure transmission of scrambled content to an end user device, the scrambled content comprising digital data, the method comprising the steps of:
(a) receiving the scrambled content at the end user device;
(b) receiving a permission message by the end user device;
(c) unscrambling the scrambled content to form unscrambled content as digital data only after receiving said permission message by the end user device;
(d) converting said unscrambled content to rescrambled content;
(e) unscrambling said rescrambled content when converting said content from digital data to an analog signal, such that step (e) is performed immediately before said analog signal is displayed; and
(f) displaying said analog signal.

91. A method for securely and precisely converting scrambled data to a final format for display, the steps of the method being performed within a secure device, the method comprising the steps of:
(a) completely unscrambling the scrambled data to an unscrambled format of data; and
(b) immediately converting said data in said unscrambled format to the final format for display, such that steps (a) and (b) are performed within the secure device, and such that said data in said unscrambled format is inaccessible externally to the secure device.

92. The method of claim 91, wherein converting scrambled data to the final format for display includes conversion of digital data to an analog signal.

93. The method of claim 92, wherein step (a) further comprises the steps of:
(i) receiving the scrambled data;
(ii) unscrambling the scrambled data to a first unscrambled data;
(iii) rescrambling said first unscrambled data to form rescrambled data; and
(iv) unscrambling said rescrambled data to form said data in said unscrambled format of data.

94. The method of claim 93, wherein the scrambled data is distributed to a plurality of secure devices, and wherein steps (iii) and (iv) are performed according to a different scheme by each secure device.

95. The method of claim 94, wherein the step of rescrambling said first unscrambled data to form said rescrambled data is performed differently by each secure device for each unscrambling operation.

96. A system for unscrambling scrambled content before display, the scrambled content being digital data and the unscrambled content being displayed as an analog signal, the system comprising:
(a) a descrambler operative to descramble the scrambled content to form descrambled content as digital data;
(b) a digital-to-analog converter which converts said unscrambled content from digital data to an analog signal, such that descrambling and digital-to-analog conversion are performed immediately before said analog signal is displayed; and
(c) a display, on which said analog signal is displayed;
wherein said descrambling and said digital-to-analog conversion are performed at physically separated locations connected by a secure channel.

97. A method for secure precision digital to analog conversion, the method comprising:
(a) encrypting digital content;
(b) receiving input, the input comprising the encrypted digital content and a key for decrypting said encrypted digital content; and
(c) connecting said encryption engine to said digital to analog converter via a secure channel,
wherein said digital content is encrypted at a location which is physically separated from the location whereat the receiving input occurs.

98. A system for secure transmission of scrambled content to an end user device, the scrambled content comprising digital data, the system comprising:
(a) receiving the scrambled content at the end user device;
(b) a receiver at the end user device which receives a permission message;
(c) a descrambler which descrambles the scrambled content to form descrambled content as digital data only after receiving said permission message by the end user device;
(d) a scrambler which converts said unscrambled content to rescrambled content;
(e) a second descrambler which descrambles the rescrambled content;
(f) a digital-to-analog converter which converts said descrambled rescrambled content from digital data to an analog signal; and
(g) a display on which the analog signal is displayed,
wherein the descrambler descrambles the scrambled content immediately before said analog signal is displayed.

99. A system for securely and precisely converting scrambled data to a final format for display, the conversion of the scrambled data to a final format being performed within a secure device, the system comprising:
(a) a descrambler which completely descrambles the scrambled data to an unscrambled format of data; and
(b) a digital to analog converter which immediately converts said data in said unscrambled format to the final format for display, such that the descrambler and the digital to analog converter are disposed within the secure device, and such that said data in said descrambled format is inaccessible externally to the secure device.

100. A system for unscrambling scrambled content before display, the scrambled content being digital data and the unscrambled content being displayed as an analog signal, the system comprising:
(a) means for unscrambling the scrambled content to form unscrambled content as digital data;
(b) means for converting said unscrambled content from digital data to an analog signal, such that the means for unscrambling and the means for converting are operative immediately before said analog signal is displayed; and
(c) means for displaying said analog signal;
wherein the means for unscrambling and the means for converting operate at physically separated locations connected by a secure channel.

101. A secure precision digital to analog converter, comprising:
(a) means for encrypting digital content;
(b) means for receiving input, the input comprising the encrypted digital content and a key for decrypting said encrypted digital content; and
(c) means for connecting said encryption engine to said digital to analog converter via a secure channel,
wherein said means for encrypting is physically separated from the means for receiving input.

102. A system for secure transmission of scrambled content to an end user device, the scrambled content comprising digital data, the system comprising:
(a) means for transmitting the scrambled content to the end user device;
(b) means for receiving a permission message by the end user device;
(c) means for unscrambling the scrambled content to form unscrambled content as digital data only after receiving said permission message by the end user device;
(d) means for converting said unscrambled content to rescrambled content;
(e) means for unscrambling said rescrambled content when converting said content from digital data to an analog signal, such that said means for unscrambling said rescrambled content operates immediately before said analog signal is displayed; and
(f) means for displaying said analog signal.

103. A system for securely and precisely converting scrambled data to a final format for display, the conversion of the scrambled data to a final format being performed within a secure device, the system comprising:
(a) means for completely unscrambling the scrambled data to an unscrambled format of data; and
(b) means for immediately converting said data in said unscrambled format to the final format for display, such that said means for completely unscrambling the scrambled data and said means for immediately converting said data are disposed within the secure device, and such that said data in said unscrambled format is inaccessible externally to the secure device.
